(19) United States
(12) Patent Application Publication
(10) Pub. No.: US 2019/0208882 A1
(43) Pub. Date: Jul. 11, 2019

(54) APPARATUS FOR ORAL SEX AND METHOD

(71) Applicants: Andrika Boshyk, Toronto (CA); Matthew Rook, Toronto (CA)

(72) Inventors: Andrika Boshyk, Toronto (CA); Matthew Rook, Toronto (CA)

(21) Appl. No.: 15/863,265

(22) Filed: Jan. 5, 2018

(51) Int. Cl. A45D 8/28; A61H 19/00

(52) U.S. Cl. CPC A45D 8/28; A45D 2008/004; A61H 19/50

(57) ABSTRACT

An apparatus includes a hair clasp configured to affix to the hair on a person's head. The hair clasp may include a quick release latch that allows the hair clasp to remain in a locked position and alternatively an unlocked position. The hair clasp may have an upper-portion and a lower-portion which may be pivotably connected. The upper portion and the lower portion of the hair clasp may include interlacing teeth coated with rubber to provide an additional clamping force when attached to the hair. A handle is included that may be configured to be gripped with one hand. A tether mechanically connects the hair-clasp to the handle at a predetermined length. The apparatus for oral sex may further be configured to be themed. The apparatus is useful for suggestive play.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of adult accessories of existing art and more specifically relates to intercourse accessories.

### RELATED ART

Sex toys have a permanent place in many homes. Adult couples tend to explore their sexuality by using various accessories that are widely available at retail outlets across the planet. These toys of an adult nature come in a broad variety of forms, and cover an even broader spectrum of human sexuality. As new interests regarding sex and sensuality are being discovered by individuals daily, new adult accessories are created to meet the demand. Human sensuality toys come in numerous form factors with an equal number of features. Erotic stimulation is a limitless landscape with a multitude of unknown and thereby untapped markets.

U.S. Pub. No. 2014/0275759 to Kin Wai LEE relates to an oral sex stimulator. The described oral sex stimulator includes a battery powered body including a battery compartment, a silicone cover and one or more controls; and a tail attached to the body, wherein the tail includes a bend adjacent to the body, an elongated arm extending away from the bend, and a hooked end at the terminal end of the tail. In some embodiments, the body is a vibrating body. In others, the body includes a heating element.

### SUMMARY OF THE INVENTION

In view of the foregoing disadvantages inherent in the known intercourse accessories art, the present disclosure provides a novel apparatus for oral sex. The general purpose of the present disclosure, which will be described subsequently in greater detail, is to provide an effective apparatus for oral sex.

An apparatus for oral sex is disclosed herein. The apparatus includes a hair clasp configured to affix to the hair on a person's head. The hair clasp may include a quick release latch that allows the hair clasp to remain in a locked position and alternatively an unlocked position. The hair clasp having an upper-portion and a lower-portion which may be pivotably connected. The upper portion and the lower portion of the hair clasp may include interlacing teeth coated with rubber to provide an additional clamping force when attached to the hair. The apparatus for oral sex includes a handle that is configured to be grasped with at least one hand. A tether mechanically connects the hair-clasp to the handle at an adjustable length. The apparatus for oral sex may further be configured to be themed.

According to another embodiment, an attaching an apparatus is also disclosed herein. The apparatus includes a providing an apparatus for oral sex, the apparatus comprising a hair-clasp, the hair-clasp configured to affix to the hair of a head, the hair-clasp having an upper-portion and a lower-portion; a handle, the handle configured to be gripped with one hand; a tether, the tether configured to mechanically connect the hair-clasp and the handle at a predetermined length; attaching the hair-clasp to the hair of a head; adjusting the tether-length; and gripping the handle with at least one hand.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an apparatus for oral sex, constructed and operative according to the teachings of the present disclosure.

FIG. 1 is a perspective view of the apparatus during an ‘in-use’ condition, according to an embodiment of the disclosure.

FIG. 2A is a perspective view of the apparatus of FIG. 1, according to an embodiment of the present disclosure.

FIG. 2B is a perspective view of the apparatus of FIG. 1, according to an embodiment of the present disclosure.

FIG. 3 is a front view of the apparatus of FIG. 1, according to an embodiment of the present disclosure.

FIG. 4 is front view of the apparatus of FIG. 1, according to an embodiment of the present disclosure.

FIG. 5 is a flow diagram illustrating a method of using the apparatus, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to intercourse accessories and more particularly to an apparatus for oral sex as used to improve the suggestive interaction between couples.

Generally, an apparatus for oral sex is a toy for couples to engage in consensual sexual interactions. The apparatus is a discreet device with no visual indications of its intimate nature of use. The apparatus comprises of a hair clasp connected to a handle with a tether of a variable length. A couple may engage in physical intimacy by attaching the hair clasp to the head of one partner while another partner holds the handle. The partner holding the handle may use the handle to control the head of the partner who has the hair clasp connected to her/his hair.

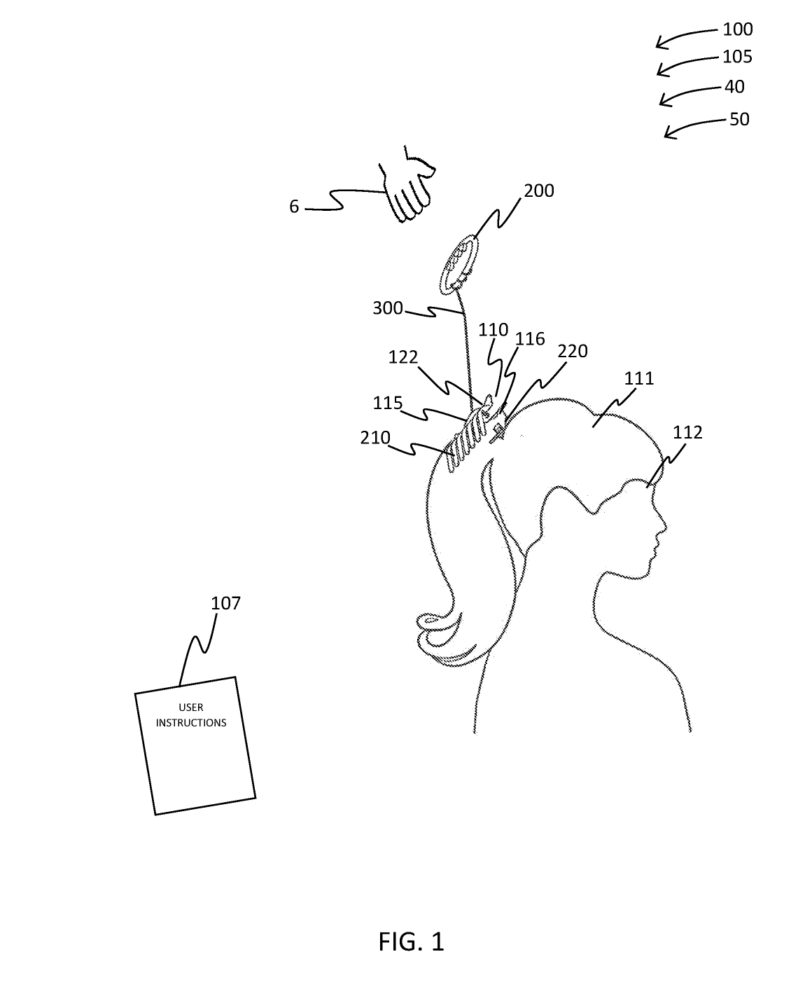

Referring now more specifically to the drawings by numerals of reference, there is shown in FIGS. 1-4, various views of an apparatus 100.

FIG. 1 shows an apparatus 100 during an ‘in-use’ condition 50, according to an embodiment of the present disclosure. Here, the apparatus 100 may be beneficial for use by a user 40 for suggestive play. As illustrated, the apparatus 100 may include a hair-clasp 110, the hair-clasp configured to affix to the hair 111 of a head 112, the hair-clasp 110 having an upper-portion 115 and a lower-portion 116. The upper-portion 115 may have an upper-teeth set 210 integrated into the structure of the upper-portion 115. The lower-portion 116 may have a lower-teeth set 220 integrated into the structure of the lower-portion 116. The apparatus 100 includes a handle 200, the handle 200 configured to be gripped with at least one hand 6. A tether 300 mechanically connects the hair-clasp 110 and the handle 200.

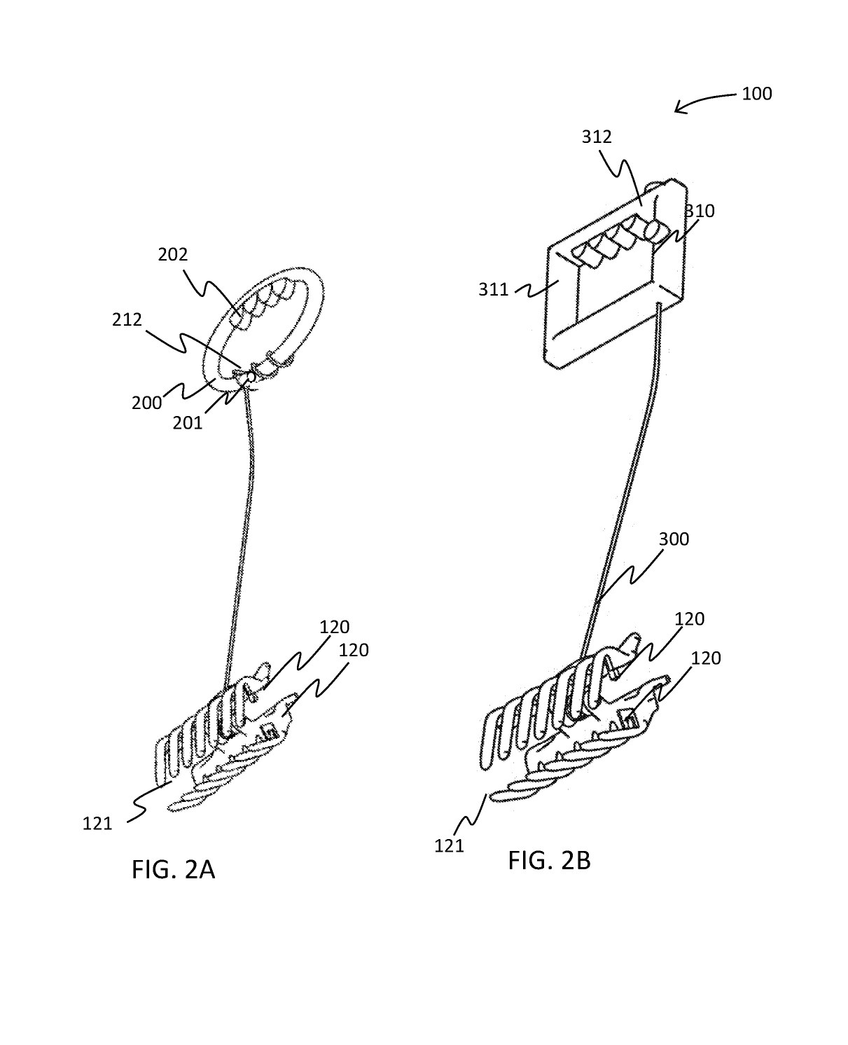

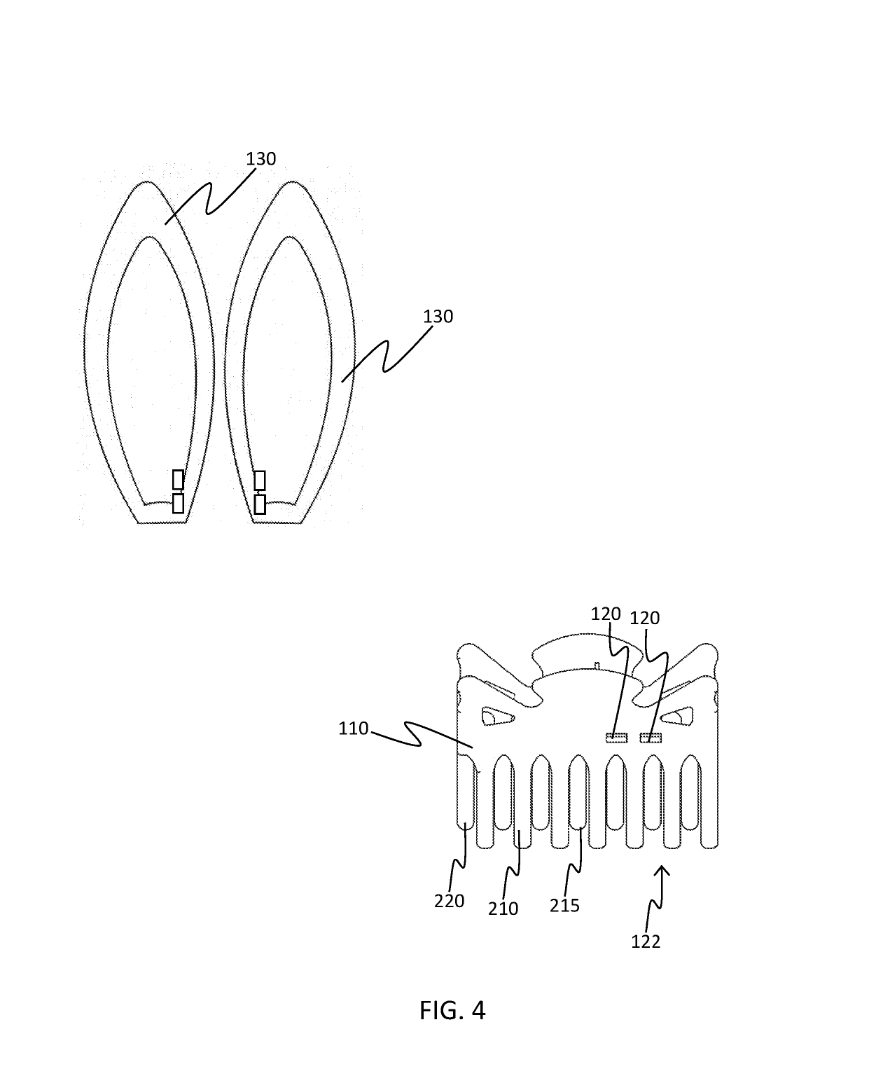

In the present embodiment, the hair-clasp 110 is affixed to the head of a user 40. The hair-clasp further includes a latch 120 (FIG. 2A), the latch 120 is configured to switch quickly between an open-state 121 (FIG. 2A) and a latched-state 122 (FIG. 4). When the hair-clasp 110 is in a latched-state 122 the lower-teeth set 220 and the upper-teeth set 210 may be configured to interlace.

According to one embodiment, the apparatus 100 be arranged as a kit 105. In particular, the apparatus 100 may further include a set of instructions 107. The instructions 107 may detail functional relationships in relation to the structure of the apparatus 100 such that the apparatus 100 can be used, maintained, or the like, in a preferred manner

FIG. 2A shows the apparatus 100 of FIG. 1, according to an embodiment of the present disclosure. As above, the apparatus 100 may include a handle 200 having handle-aperture 201 configured to receive the tether. The tether 300 may pass through the handle-aperture 201, where the handle 200 may provide a means-of-fastening 212 the tether 300 to the handle 200. Other fastening methods may include the tether 300 wrapping around, tying, and in any form binding to the handle 200. As pictured, the handle may comprise a layer of rubber 202 configured for comfort. In this embodiment, the layer of rubber 202 is anatomically designed for gripping functionality. Further embodiments where the handle 200 may comprise any shape, pattern or size are conceived. The handle 200 may further include clips, apertures and all conceivable means of fastening for additional accessories and auxiliary products.

FIG. 2B illustrates one of yet many embodiments of the apparatus 100. In this embodiment, the handle 200 may define a storage-space 311 for the tether 300. The tether 300 may be wound around a pre-tensioned spool-mechanism 310 configured to retract the tether into the storage-space 311 of the handle 200. Further pictured may be a lock-button 312 configured to inhibit the angular rotation of the spool-mechanism 310.

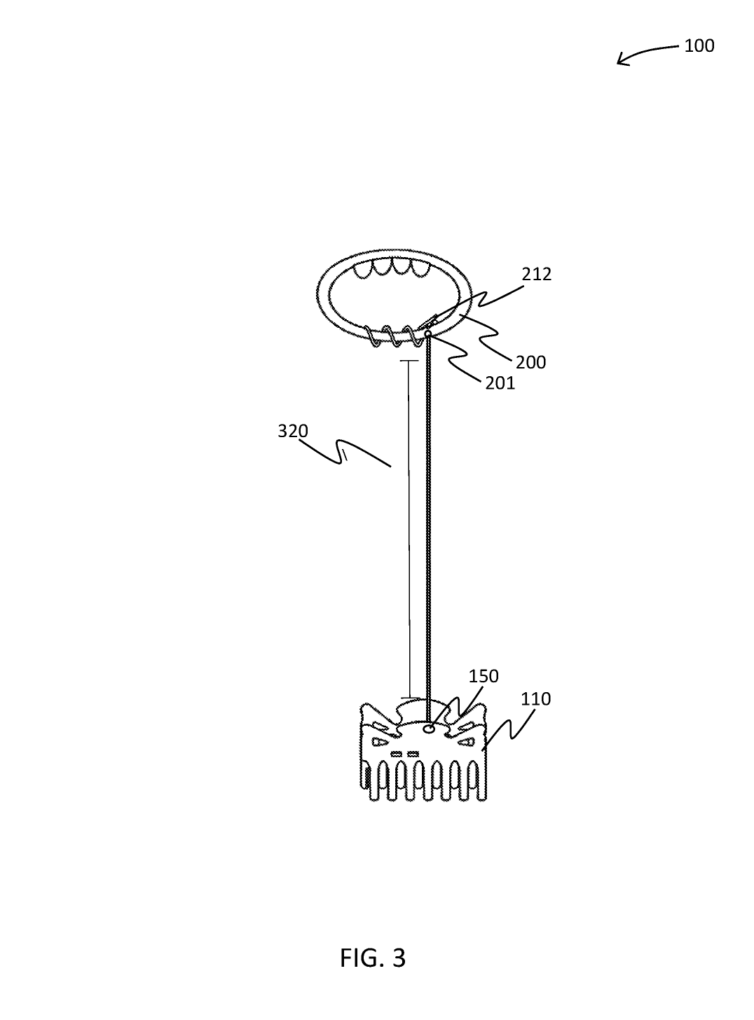

FIG. 3 is front view of the apparatus 100 of FIG. 1, according to an embodiment of the present disclosure. As shown, the apparatus 100 comprises of a hair-clasp 110, and a handle 200, mechanically connected with a tether 300. The provided hair-clasp 110 may include a clasp-aperture 150 defining a passage for the tether 300 to pass through. The provided handle 200 may include a handle-aperture 201 defining a passage for the tether 300 to pass through. A tether-length 320 may be defined by the length of the tether 300 between the hair-clasp 110 and the handle 200, the tether-length 320 may be adjusted from the handle 200. Adjustments to the tether-length 320 may be made by pulling the tether 300 through the handle-aperture 201. The tether 300 may be secured to the handle 200 by a means-of-fastening 212. The tether 300 connecting the hair-clasp 110 to the handle 200 may comprise any length of material including but not limited to metal, cotton, plastic and any polymer thereof.

FIG. 4 is a front view of the apparatus 100 of FIG. 1, according to an embodiment of the present disclosure. Shown in FIG. 4 is a possible embodiment of the hair-clasp 110 having an upper-teeth set 210 and a lower-teeth 220 set coated with a soft-material 215. The soft-material 215, in this embodiment, may be rubber configured to provide additional clamping force when the hair-clasp 110 is in the latched-state 122. The illustration further describes the hair-clasp 110 having accessory-apertures 120 for hair-clasp-accessories 130. The hair-clasp 110 may be configured to be themed. The accessory-apertures 120 of the hair-clasp 110 may be configured to receive all conceived themed hair-clasp-accessories 130.

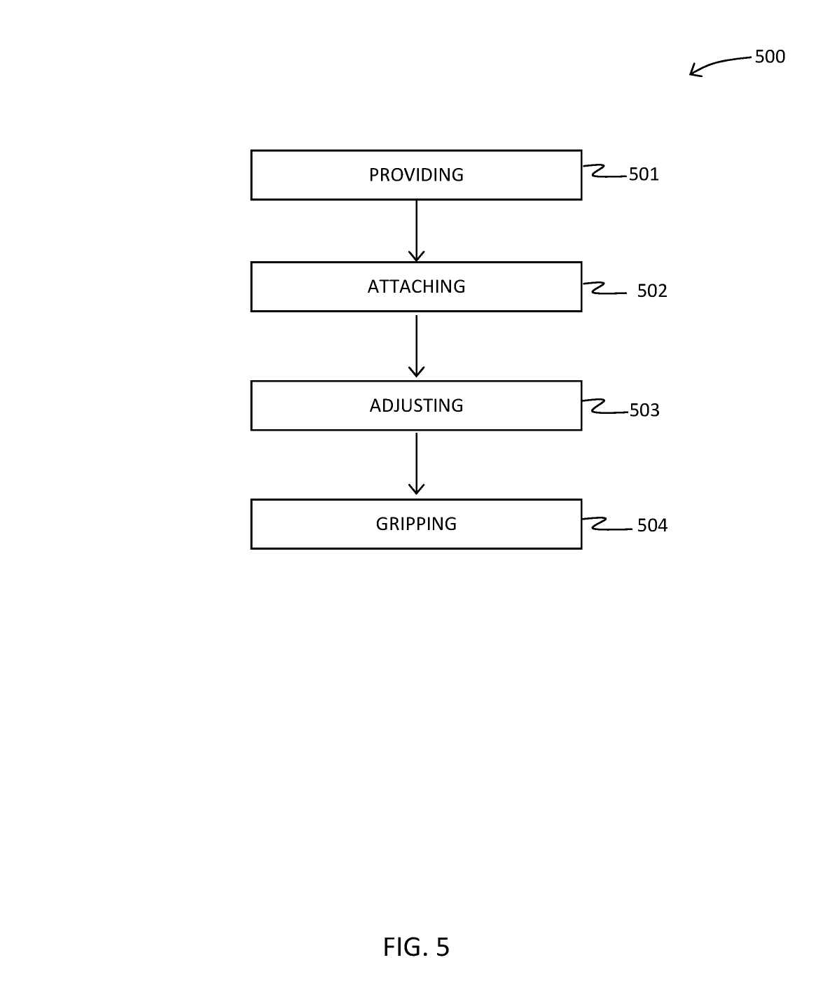

FIG. 5 is a flow diagram illustrating a method for using 500 an apparatus 100, according to an embodiment of the present disclosure. In particular, the method for suggestive play 500 may include one or more components or features of the apparatus 100 as described above. As illustrated, the method for using an apparatus 500 may include the steps of: step one 501, providing an apparatus for oral sex, the apparatus comprising a hair-clasp, the hair-clasp configured to affix to the hair of a head, the hair-clasp having an upper-portion and a lower-portion; a handle, the handle configured to be gripped with one hand; a tether, the tether configured to mechanically connect the hair-clasp and the handle at a predetermined length; step two 502, attaching the hair-clasp to the hair of a head; step three 503, adjusting the tether-length; step 504, gripping the handle with at least one hand.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for suggestive play, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An apparatus for oral sex, the apparatus comprising:
a hair-clasp, the hair-clasp configured to affix to the hair of a head, the hair-clasp having an upper-portion and a lower-portion;
a handle, the handle configured to be gripped with one hand; and
a tether, the tether configured to mechanically connect the hair-clasp and the handle at a predetermined length;

2. The apparatus of claim 1, wherein the upper-portion and the lower-portion are pivotably connected.

3. The apparatus of claim 1, wherein the upper-portion further comprises an upper-teeth set.

4. The apparatus of claim 1, wherein the lower-portion further comprises a lower-teeth set.

5. The apparatus of claim 1, wherein the hair-clasp further includes a clasp-aperture configured to receive the tether.

6. The apparatus of claim 1, wherein the hair-clasp includes a latch.

7. The apparatus of claim 1, wherein the hair-clasp has an open-state and a latched-state.

8. The apparatus of claim 1, wherein the upper-teeth set and the lower-teeth set are configured to interlace when the hair-clasp is in a latched-state.

9. The apparatus of claim 1, wherein the handle further includes a handle-aperture configured to receive the tether.

10. The apparatus of claim 1, further comprising a tether-length that is defined by the length of the tether between the hair-clasp and the handle, the tether-length is adjusted from the handle.

11. The apparatus of claim 7, wherein the upper-teeth set and the lower-teeth set are coated with a soft-material.

12. The apparatus of claim 11, wherein the soft-material is rubber configured to provide additional clamping force when the hair-clasp is in the latched-state.

13. The apparatus of claim 1, wherein the tether is made of a stretchable material.

14. The apparatus of claim 1, wherein the handle includes a rubber layer configured for comfort.

15. The apparatus of claim 1, wherein the hair-clasp includes accessory-apertures for hair-clasp-accessories.

16. The apparatus of claim 1, wherein the apparatus is configured to be themed.

17. An apparatus, the apparatus comprising:
a hair-clasp, the hair-clasp configured to affix to the hair of a head, the hair-clasp having an upper-portion and a lower-portion;
a handle, the handle configured to be gripped with one hand; and
a tether, the tether configured to mechanically connect the hair-clasp and the handle at a predetermined length;
wherein the upper-portion and the lower-portion are pivotably connected;
wherein the upper-portion further comprises an upper-teeth set;
wherein the lower-portion further comprises a lower-teeth set;
wherein the hair-clasp further includes a clasp-aperture configured to receive the tether;
wherein the hair-clasp includes a latch;
wherein the hair-clasp has an open-state and a latched-state;
wherein the upper-teeth set and the lower-teeth set are configured to interlace when the hair-clasp is in a latched-state;
wherein the handle further includes a handle-aperture configured to receive the tether;
wherein the tether further comprising a tether-length that is defined by the length of the tether between the hair-clasp and the handle, the tether-length is adjusted from the handle;
wherein the upper-teeth set and the lower-teeth set are coated with a soft-material;
wherein the soft-material is rubber configured to provide additional clamping force when the hair-clasp is in the latched-state;
wherein the tether is made of a stretchable material;
wherein the handle includes a rubber layer configured for comfort;
wherein the hair-clasp includes accessory-apertures for hair-clasp-accessories;
wherein the apparatus is configured to be themed;

19. A method of using apparatus, the method comprising the steps of:
providing an apparatus for oral sex, the apparatus comprising a hair-clasp, the hair-clasp configured to affix to the hair of a head, the hair-clasp having an upper-portion and a lower-portion; a handle, the handle configured to be gripped with one hand; a tether, the tether configured to mechanically connect the hair-clasp and the handle at a predetermined length;
attaching the hair-clasp to the hair of a head;
adjusting the tether-length; and
gripping the handle with at least one hand.
